(19) United States
(12) Patent Application Publication
(10) Pub. No.: US 2007/0200815 A1
(43) Pub. Date: Aug. 30, 2007

(54) CHARGE SHARING METHOD AND APPARATUS FOR DISPLAY PANEL

(76) Inventor: Liang-Hua Yeh, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,878

(22) Filed: Feb. 26, 2006

(51) Int. Cl. G09G 3/36

(52) U.S. Cl. 345/98

(57) ABSTRACT

A charge-sharing method and apparatus for display panel including at least two data channels are provided. The charge-sharing method includes the following steps. First, one data channel is connected with another data channel at a first time-point of a period during which the pixels are turned on. The connections among the data channels are turned off at a second time-point of the period during which the pixels are turned on. Thereby, the display signal can be transmitted to the data channel in the display panel.

### BACKGROUND OF THE INVENTION

1. Field of Invention

The present invention relates to a drive for display panel, and more particular to a charge sharing method and apparatus for a display panel.

2. Description of Related Art

FIG. 1 depicts a block diagram of a generic display. FIG. 2 is a timing diagram illustrating each of the signals in FIG. 1. Referring to FIGS. 1 and 2, assuming the display panel 140 is an n×m display panel, wherein m and n are integers. A timing controller 110 outputs both a vertical synchronization signal STV and an enabling signal OE to a scan driver 120. In the scan driver 120, a shift register 121 is used to shift the received vertical synchronization signals STV progressively, so as to output multiple scan signals. A level shifter 122 receives the scan signals output from the shift register 121, and determines whether to output the scan signals SS(1)-SS(m) to the scan channel of display panel 140 through a buffer based on the output enabling signal OE. For illustrative convenience, only scan signals SS(1)-SS(3) are shown in FIG. 2.

In accordance with the timing of the scan signals output from the scan driver 120, a timing controller 110 also outputs a horizontal synchronization signal STH, digital display data DD, and latch signal LP to a data driver 130. In the data driver 130, a shift register 131 is used to shift the received horizontal synchronization signal STH progressively, so as to output multiple latch signals of different phase shifts to a first line latch 132. The first line latch 132 latches the digital display data DD in the corresponding channel according to the latch signal output from the shift register 131. A second line latch 133 stores the latch data output from the first line latch 132 according to the latch signal LP output from the timing controller 110 after all channels of the first line latch 132 have completed latching data. Then, the digital data output from the second line latch 133 are converted into analog display signals AD(1)-AD(n) by a digital-to-analog converter 134. The analog display signals AD(1)-AD(n) are transmitted to the data channels of the display panel 140 through the buffer. For illustrative convenience, only the display signal AD(1) is illustrated in FIG. 2.

In order to improve the dynamic performance of the display panel 140, the display panel 140 is generally driven by using polarity inversion technology. Taking the display signal AD(1) as an example, referring to FIG. 2, the display signal AD(1) is inverted to negative polarity during the period when the scan signal SS(1) is enabled, and to positive polarity during the period when the scan signal SS(2) is enabled, and is inverted again to negative polarity during the period when the scan signal SS(3) is enabled. The above positive polarity and negative polarity are defined with reference to the level of a common voltage VCOM. The data driver 130 consumes a large amount of power when inverting between the positive and negative polarities for the display signal AD(1). In order to reduce the amplitude of display signals output from the data driver so as to reduce the consumption of the electricity, charge-sharing technology is generally adopted.

With charge-sharing technology, a switch SW is arranged between an odd data channel and an even data channel, as shown in FIG. 3. For illustrative convenience, only the first data channel (providing the display signal AD(1)) and second data channel (providing the display signal AD(2)) are taken as example in FIG. 3. With a control switch SW, the odd data channel and even data channel are connected with each other before inverting between the positive and negative polarities of the display signal of the data channel, such that the charges are evenly distributed in the odd data channel and the even data channel, therefore the potential of the odd and even data channels is effected in advance to fall (rise) to be approximately the common voltage VCOM. Accordingly, for the data driver, the voltage level of the data channel need only to be discharged to a negative polarity level (or charged to a positive polarity level) from approximately the common voltage VCOM, i.e., the amplitude of display signal output from the data driver is reduced, thus saving electricity during polarity inversion.

FIG. 4 is a signal timing diagram illustrating the conventional charge-sharing method. Referring to FIGS. 1, 3, and 4, the conventional charge-sharing method is implemented when the latch signal LP is at a high level, i.e., each of the switches SW between the odd data channel and even data channel is in accordance with the control of latch signal LP, such that adjacent odd and even data channels are first connected with each other, resulting in a neutralization of the polarities of positive and negative charges in both data channels (i.e., falling to the common voltage VCOM from the voltage of positive polarity and rising to the common voltage VCOM from the voltage of negative polarity respectively). Then, the switch SW is turned off when the latch signal LP is at its low end, and each of the output voltages of the odd and even data channels are effected to fall (rise) from the VCOM voltage to a desired voltage of negative (positive) polarity. As such, for the data driver, it is unnecessary to change the voltage of positive polarity to the voltage of negative polarity (or change the voltage of negative polarity to the voltage of positive polarity) when driving data channels. Therefore, the current output to data channels by the data driver is reduced, thereby achieving the purpose of reducing the power consumption.

However, the conventional charge-sharing technology is implemented during the period when all the scan lines are disabled (when the latch signal LP is at a high level), i.e., the charge-sharing method is implemented during the period when all of the pixels of the display panel 140 are turned off. Therefore, with the conventional technology, only the polarities of positive and negative charges on adjacent odd data lines and even data lines can be neutralized, but the pixel charges in the display panel 140 cannot be neutralized all together. Consequently, the power-saving function of the conventional charge-sharing method is poor.

### SUMMARY OF THE INVENTION

An object of the present invention is to provide a charge-sharing method for a display panel, so as to improve the conventional charge-sharing method of controlling signals, thereby optimizing the power-saving function.

Another object of the present invention is to provide a charge-sharing apparatus for a display panel to achieve the above object with an embodied apparatus.

Based on the above and other purposes, the invention provides a charge-sharing method for a display panel, wherein the display panel comprises at least two data channels. The charge-sharing method includes the following steps. First, a connection is made among data channels at a first time-point of a period when the pixels are turned on. The connection among the data channels is turned off at a second time-point of the period when the pixels are turned on. Thereby, the display signal can be respectively transmitted to the data channel in the display panel.

From another perspective, the invention provides a charge-sharing apparatus for display panel, wherein the display panel comprises at least two data channels and at least one scan channel. The charge-sharing apparatus includes a scan driver, a data driver, at least one switch, and a timing controller. The scan driver is electrically connected to the scan channels so as to determine, according to the output enabling signal, whether to output a scan signal, such that the on/off of all pixels on the scan channel is controlled. The data driver is electrically connected to the data channels so as to latch and output a display signal according to the latch signal so as to drive the display panel. The switch/es is/are electrically connected among data channels so as to determine, according to the control signal, whether to connect one data channel with the other data channel. The timing controller is electrically connected to the switch (or switches), the data driver, and the scan driver, so as to control the scan driver via the output enabling signal during the period when the pixels are turned on, such that all pixels on the scan channels are turned on. At a first time-point of the period when the pixels are turned on, the timing controller controls a switch with the control signal, such that one data channel is connected with other data channel. And at a second time-point of the period when the pixels are turned on, the timing controller controls a switch with the control signal, such that the connection between the data channels is turned off. Thereby, the display signal can be respectively transmitted to the data channel in the display panel by the data driver.

The conventional charge-sharing function is only capable of neutralizing the polarities of positive and negative charges on adjacent data lines, so that the power-saving function cannot be optimized. In the present invention, charge-sharing is completed during the period when the pixels are turned on. As a result, not only the polarities of positive and negative charges on adjacent data channels but also the polarities of positive and negative charges on adjacent odd and even pixels on the corresponding scan lines are neutralized, thus optimizing the power-save effect.

In order to make the aforementioned and other objects, features and advantages of the present invention comprehensible, a preferred embodiment accompanied with figures is described in detail below.

### BRIEF DESCRIPTION OF THE DRAWINGS

FIG. 1 depicts a block diagram of a general display;

FIG. 2 is a timing diagram illustrating each of the signals in FIG. 1;

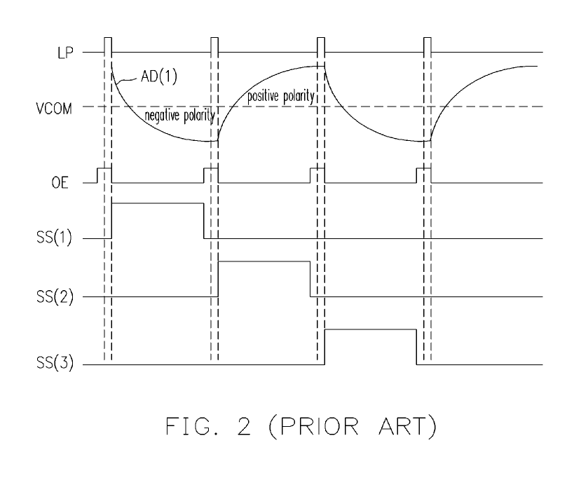

FIG. 3 illustrates a charge-sharing method for arranging a switch between odd and even data channels;

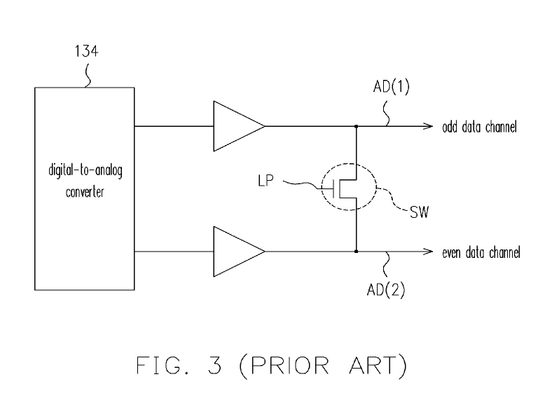

FIG. 4 is a signal timing diagram illustrating the conventional charge-sharing method;

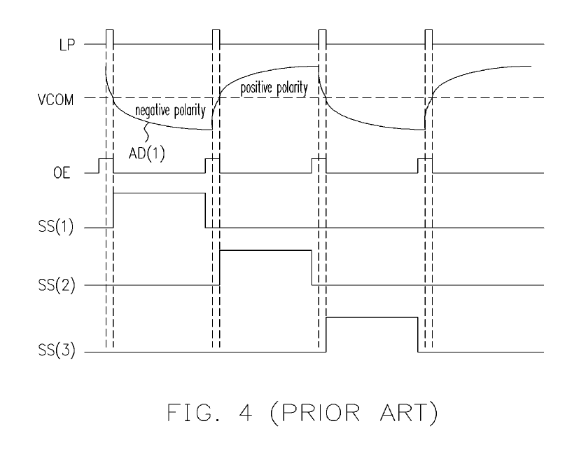

FIG. 5 depicts a block diagram of a display having a charge-sharing function according to an embodiment of the invention;

FIG. 6 is a timing diagram illustrating each of the signals in FIG. 5 according to an embodiment of the invention;

FIG. 7 is a circuit diagram illustrating a delay circuit according to an embodiment of the invention; and

FIG. 8 is a timing diagram illustrating each of the signals in FIG. 5 according to another embodiment of the invention.

### DESCRIPTION OF EMBODIMENTS

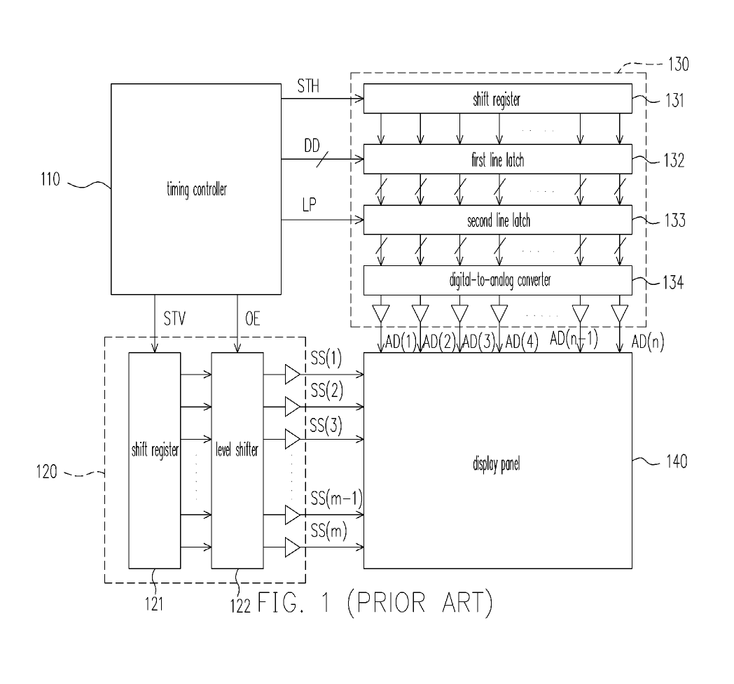

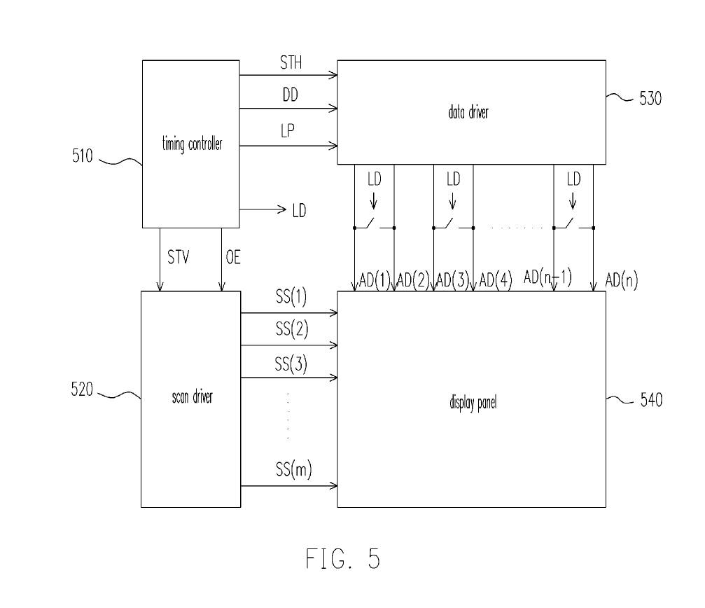

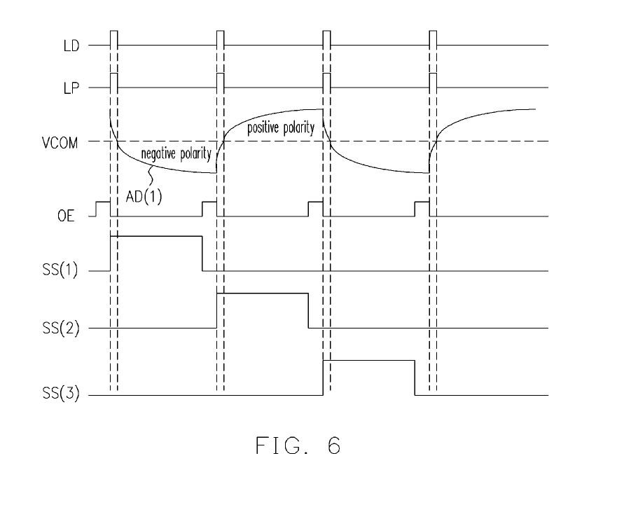

FIG. 5 depicts a block diagram of a display having a charge-sharing function according to an embodiment of the invention. The implementation of the data driver 530 and the scan driver 120 in the figure is the same as that of the data driver 130 and the scan driver 120 in FIG. 1. FIG. 6 is a timing diagram illustrating each of the signals in FIG. 5. Referring to FIGS. 5 and 6, the display panel 540 is assumed to be a thin film transistor-liquid crystal display panel (TFT-LCD panel) having n×m pixels, wherein m and n are integers.

The timing controller 510 outputs a vertical synchronization signal STV and an enabling signal OE to the scan driver 520. The scan driver 520 determines, according to the output enabling signal OE, whether to output the scan signals SS(1)-SS(m) to the scan channels of the display panel 540. Herein, the ‘period when the pixels are turned on’ refers to a period in which the enabling signal OE is at a low level (i.e., outputting the scan signals SS(1)-SS(m)). If not at the period when the pixels are turned on, the scan driver 520 will turn off all the pixels on the corresponding scan channels. For illustrative convenience, only the scan signals SS(1)-SS(3) are shown in FIG. 6.

In accordance with the timing of scan signals SS(1)-SS(m) output by the scan driver 520, the timing controller 510 also outputs a horizontal synchronization signal STH, a digital display data DD, and a latch signal LP to the data driver 530. As for the driving method of the general TFT-LCD panel, the data driver 530 outputs the display signals AD(1)-AD(n) when the latch signal LP is at a low level, while the scan driver 520 outputs the scan signals SS(1)-SS(m) when the enabling signal OE is at a low level. The display signals AD(1)-AD(n) are output to the corresponding data channels in the display panel 540 respectively by the data driver 530. For illustrative convenience, only the display signal AD(1) is illustrated in FIG. 6.

In the embodiment, a switch is electrically connected between each odd data channel and even data channel. These switches are used to determine, according to the control signal LD, whether to connect the odd data channel with even data channel. In addition, the control signal LD and the latch signal LP are set to be the same signal in this embodiment.

According to the spirit of the present invention, the timing controller 510 is modified in the embodiments below, such that the timing of the enabling signal OE output from the timing controller 510 leads the latch signal LP; or, the timing of the latch signal LP lags behind the enabling signal OE. The timing controller 510 outputs the enabling signal OE to control the scan driver 520 during the corresponding period when the pixels are turned on, causing the scan driver 520 to turn on all pixels on the corresponding scan channels. At a first time-point of the period when the pixels are turned on (when the latch signal LP is at a high level), the timing controller 510 controls each switch with the control signal LD, such that the odd data channels are connected with the even data channels. And at a second time-point of the period when the pixels are turned on (when the latch signal LP is at a low level), the timing controller 510 controls each switch with the control signal LD, such that the connections among odd and even data channels are turned off. At this time, the display signals AD(1)-AD(n) are transmitted to the corresponding data channel in the display panel 540 respectively by the data driver 530. Therefore, in the embodiment, the data channels and associated pixels can be used together to perform a neutralization of positive and negative polarities (i.e., charge-sharing) at the same time. If not at the period when the pixels are turned on, the timing controller 510 controls each switch such that the connections among the data channels are turned off.

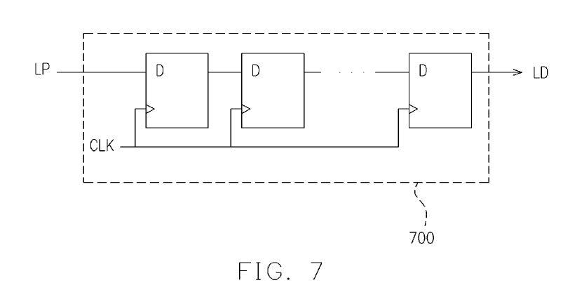

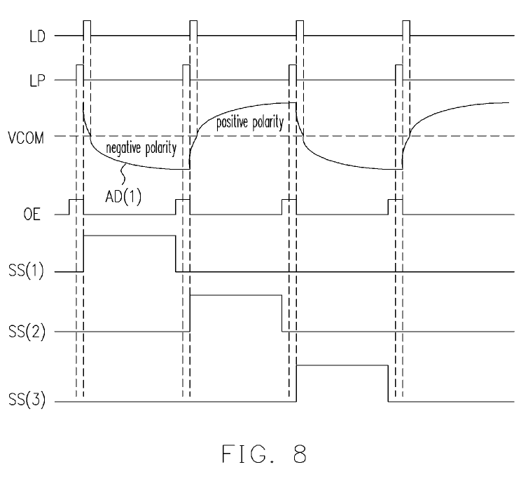

In a second embodiment, the time-point for initiating the charge-sharing by the data driver 530 is modified, but the latch signal LP and the enabling signal OE are operated in the conventional way. In the embodiment, a delay circuit 700 (as shown in FIG. 7) is arranged for receiving and delaying the latch signal LP so as to output the control signal LD in FIG. 5. The delay circuit 700 is formed by multiple flip-flops connected in series. Each of the flip-flops is triggered by the system clock CLK. The delay time of the delay circuit 700 is determined by the number of flip-flops connected in series in the delay circuit 700. The signal timing diagram in the embodiment is shown in FIG. 8.

Referring to FIGS. 5, 7 and 8, due to the delay of the delay circuit 700, the control signal LD lags behind the latch signal LP in the timing. At the first time-point of the period when the pixels are turned on, i.e., a period after the falling end of the latch signal LP (when the control signal LD is at a high level), the timing controller 510 controls each of the switches with the control signal LD, such that the odd data channels are connected with the even data channels. At the second time-point of the period when the pixels are turned on (when the control signal LD is at a low level), the timing controller 510 controls each of the switches with the control signal LD, such that the connections among odd and even data channels are turned off. At this time, the display signals AD(1)-AD(n) are transmitted to the corresponding data channels in the display panel 540 respectively by the data driver 530. Therefore, the data channels and the associated pixels can also be used to perform the neutralization of positive and negative polarities (i.e., charge-sharing) at the same time in this embodiment.

The method of generating the control signal LD is not limited to the embodiments described above. It is known to those skilled in the art that any suitable method can be used to generate the control signal LD. The designers can decide the width of control signal LD (i.e., the time length of charge-sharing) as desired.

In view of the above, since in the present invention charge-sharing can be completed during the period when the pixels are turned on, not only the polarities of positive and negative charges on adjacent data channels but also the polarities of positive and negative charges on adjacent odd and even pixels on corresponding scan lines can be neutralized. As such, the current output from the data driver is reduced greatly, thus further enhancing the power-saving function.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A charge-sharing method for a display panel including at least two data channels, the charge-sharing method comprising:
connecting the data channels among one another at a first time-point of the period when pixels are turned on; and
disconnecting among the data channels at a second time-point of the period when pixels are turned on, such that display signal is respectively transmitted to the data channel in the display panel.

2. The charge-sharing method for a display panel as claimed in claim 1, wherein the display panel further comprises at least one scan channel and all pixels on the scan channel are turned on by control of the scan channel during the period when the pixels are turned on.

3. The charge-sharing method for a display panel as claimed in claim 2, further comprising:
turning off all the pixels on the scan channel by control of the scan channel if not at a period when the pixels of the scan channel are turned on.

4. The charge-sharing method for a display channel as claimed in claim 1, further comprising:
disconnecting among the data channels if not at the period when the pixels are turned on.

5. The charge-sharing method for a display channel as claimed in claim 1, wherein the display panel comprises an LCD panel.

6. A charge-sharing apparatus for a display panel including at least two data channels and at least one scan channel, the charge-sharing apparatus comprising:
a scan driver electrically connected to the scan channel to determine, according to an output enabling signal, whether to output a scan signal, so as to control on/off of all pixels on the scan channel;
a data driver electrically connected to the data channels to latch and output a display signal according to a latch signal, so as to drive the display panel;
at least one switch electrically connected between data channels to determine, according to a control signal, whether to short the data channels; and
a timing controller electrically connected to the switch, the data driver, and the scan driver so as to control the scan driver with the output enabling signal during a period when the pixels are turned on such that all pixels on the scan channel are turned on;
wherein at a first time-point of the period when the pixels are turned on, the timing controller controls the switch with the control signal such that one data channel is connected with another data channel; and
at a second time-point of the period when the pixels are turned on, the timing controller controls the switch with the control signal such that disconnecting among the data channels, thereby the display signal is respectively transmitted to the data channels in the display panel by the data driver.

7. The charge-sharing apparatus for a display panel as claimed in claim 6, wherein the output enabling signal leads the latch signal in timing.

8. The charge-sharing apparatus for a display panel as claimed in claim 7, wherein the control signal and the latch signal are a same signal.

9. The charge-sharing apparatus for a display panel as claimed in claim 6, wherein the control signal lags behind the latch signal in timing.

10. The charge-sharing apparatus for a display panel as claimed in claim 6, further comprising:
a delay circuit for receiving and delaying the latch signal, so as to output the control signal.

11. The charge-sharing apparatus for a display panel as claimed in claim 6, wherein if not at a period when the pixels of the scan channel are turned on, all pixels on the scan channel are turned off by the scan driver.

12. The charge-sharing apparatus for a display panel as claimed in claim 6, wherein if not at a period when the pixels are turned on, the timing controller controls the switch to turn off connection among the data channels.

13. The charge-sharing apparatus for a display panel as claimed in claim 6, wherein the display panel comprises an LCD panel.
